(19) United States
(12) Patent Application Publication
(10) Pub. No.: US 2007/0127617 A1
(43) Pub. Date: Jun. 7, 2007

(54) Nuclear fission fragment kinetic energy rocket engine

(76) Inventor: Donald Gene Sutherland, Folsom, CA (US)

Correspondence Address: Donald G. Sutherland, 185 North Grant Lane, Folsom, CA, 95630, US

(21) Appl. No.: 11/290,027

(22) Filed: Dec. 1, 2005

(51) Int. Cl. G21D 5/02

(52) U.S. Cl. 376/318

(57) ABSTRACT

A unique space propulsion engine is disclosed, which directly uses the kinetic energies of nuclear fission fragments to generate thrust. At the moment of fission, approximately 85% of the total energy produced is kinetic, contained within fission fragments traveling at 4% the speed of light. The propulsion of rockets and other space devices is conventionally accomplished by hurling mass overboard at high velocities, in accordance with the principles of Newton's third law of motion. An important parameter for quantifying propulsion performance is specific impulse (Isp). Propulsion technologies that support today's rocket missions are primarily based on chemical reactions to produce thrust, and are characterized by Isp values peaking at about 400 seconds. Space concepts using nuclear energy solid-core reactors to heat and exhaust a stored material might operate up to 800 seconds, while more advanced nuclear gas-core reactors and nuclear explosive propulsion have a theoretical limit in the 3000-6000 seconds range. The theoretical Isp of fission fragment kinetic energy propulsion is 1,220,000 seconds, a quantum leap above current technologies and other advanced concepts, up to the level essential for missions to the outer reaches of our solar system and beyond.

### FEDERALLY SPONSORED RESEARCH

Not Applicable

### SEQUENCE LISTING OR PROGRAM

Not Applicable

### FIELD OF THE INVENTION

This invention relates to a propulsion engine for travel to the outer reaches of our solar system and beyond. More specifically, it relates to a unique structure to perform space propulsion, directly utilizing the kinetic energy of atom fragments produced by nuclear fissions.

### BACKGROUND OF THE INVENTION

Newtons's third law of motion teaches that rocket propulsion is based on the reaction principle—for every action there is an equal and opposite reaction. The thrust that propels a rocket in the forward direction is the opposite reaction force on its structure due to the action force, which is created by the ejection of high-velocity matter in the aft direction.¹
¹ Pedersen, page 15; Young and Freedman, page 8-7; Zaehringer, page 54.

Chemical propulsion, by far the most common of all concepts in use today for rockets and other space-related propulsion devices, reacts chemicals to produce high temperature combustion gases. Propulsion is accomplished by expanding said gases through a convergent-divergent nozzle to increase their velocity, thereby exhausting the gases overboard in the aft direction (action force), which is countered by a forward thrust (reaction force) on the rocket structure.

A key parameter used in evaluating propulsion candidates for deep space is specific impulse (Isp). Temperatures that can be reached by chemical reaction are limited by the energy level of chemical bonds, thereby limiting the Isp of chemical propulsion devices to approximately 400 seconds. Advanced space concepts using a nuclear solid core reactor to heat a stored material, and exhaust it in gaseous form through a nozzle, might operate in the Isp 800 seconds range. The theoretical Isp of a nuclear gas core rocket has been estimated to be as high as approximately 3000 seconds.²
² Rom, U.S Pat. No. 3,202,582, column 1, line 69-column 2, line 13.

At the moment of nuclear fission of an atom of fully enriched fissionable uranium isotope number 235 (U-235), approximately 85% of the total energy release is in the form of fission fragment kinetic energy.³ At fission, each atom releases˜200 million electron volts (Mev) of energy, consisting of:

| fission fragment kinetic energy | 170 Mev |
|---|---|
| beta particles, gamma rays, neutrons, neutrinos | 30 Mev |
| total fission energy per U-235 atom | ˜ 200 Mev |
| fission fragment kinetic energy | ˜85% |

³ Etherington, pages 1-26, 2-2.

The velocities at fission of heavy and light fragments average 1.0E9 and 1.4E9 centimeters per second (cm/sec) respectively,⁴ or 1.2E9/3.0E10=4% the speed of light. The nuclear fission fragment kinetic energy rocket engine (FKR) achieves a theoretical Isp of well over a million seconds by directly utilizing the kinetic energy of fission to produce spacecraft thrust, prior to their kinetic energy conversion to thermal energy.
⁴ Weinberg and Wigner, page 131.

$$\begin{matrix}Theoretical Isp = \frac{exhaust velocity}{gravitational constant} \\ = \frac{1.2 E 9 cm \text{/} sec}{981 cm \text{/} sec 2} \\ = 1 , 220 , 000 seconds .\end{matrix}$$

### DESCRIPTION OF PRIOR ART

Propulsion concepts that have been proposed for deep space include those listed below, together with applicant's calculated values for corresponding fission fragment kinetic energy propulsion. No concept yet has gained acceptance by the space community as a baseline for future national or international development.

During the 1960s and 1970s nuclear rockets, both solid-core and gas-core concepts, received broad attention. These concepts are designated in the art as nuclear heat-transfer rockets. Unlike FKR, these rockets transfer nuclear heat to hydrogen gas to produce rocket trust. Four patented gas-core rocket conceps,⁵ three assigned to the National Aeronautics and Space Administration and one assigned to General Electric Company, identify prior art whose patent protection has expired, and now is available to support current and future space propulsion engines. The prior art from these sources which is incorporated into the FKR engine include: fissionable fuel supply to a fission zone, neutron supply to said zone, neutron supply on-off control, and neutron—fissionable material interaction to cause fissions. An additional nuclear prior art, the use of molten metal coolants in high temperature service,⁶ similarly is incorporated.
⁵ Rom U.S Pat. No. 3,202,582, Aug. 24, 1965; Rom U.S Pat. No. 3,270,496, Sept. 6, 1966; Rom U.S Pat. No. 3,574,057, Apr. 6, 1971; and Weinbaum 3,714,782, Feb. 6, 1973.

⁶ Etherington 13-80 through 13-104; U.S. Department of Energy, FFTF@rl.gov.

Particle acceleration concepts, such as those requiring electrical or magnetic fields to accelerate charged particles, rely on a nuclear reactor to provide electricity. In such cases, the flow of energy from the creation of fission fragments to final usage of the creation must pass through a series of energy changes, each step requiring components and complexities. Nuclear fission fragments are created and held within a nuclear reactor shell, converting fission fragment kinetic energy into thermal energy, which is transported to and energizes the moving components of a mechanical energy cycle such as Rankine or Brayton to generate electrical energy,⁷ which is conditioned to a voltage and current usable by a specific particle acceleration concept to create electrical or magnetic fields, which accelerate charged particles to create high specific impulse propulsion and heat. Conversely, in the FKR engine, nuclear fission fragments directly create high specific impulse propulsion and heat.
⁷ Langton, pages 155, 156.

Although photon concepts offer high Isp, their thrust-to-weight values are extremely low. This characteristic is due to their propulsion being created by photons of energy, rather than by the ejection of mass at high velocity. An additional limitation of solar photon concepts is the weakening of our sun's energy rays (lower thrust) as distances from the sun increase.

Two performance criteria prominent in evaluations of space propulsion candidates are Isp and thrust/weight ratio. Values for these characteristics are reported in the literature for conventional and advanced concepts.⁸ Although direct conversion of fission fragment kinetic energy has been proposed to produce electromagnetic radiations,⁹ and to generate electric power for space,¹⁰ no corresponding proposal for space propulsion has been identified.
⁸ Pedersen, page 38.

⁹ Fletcher, 4,075,057, page 10, paragraph 5.

¹⁰ Heindl, page 80.

| Propulsion Method | Isp. seconds | Thrust/Weight Ratio |
|---|---|---|
| Chemical, state-of-the-art | 400 | 10 |
| Nuclear solid-core heat exchanger | 800 | 10 |
| Nuclear gas-core heat exchanger | 3,000 | 5 |
| Nuclear explosive propulsion¹¹ | 6,000 | 2 |
| Magnetohydrodynamics | 10,000 | 0.0001 |
| Nuclear ion engine | 30,000 | 0.0003 |
| Fission Fragment K.E. Propulsion | >1,000,000 | 0.0002 |
| Nuclear photon engine | 30,000,000 | 0.00001 |
| Photon reflection (solar sail) | infinite | 0.00001 |

### SUMMARY OF THE INVENTION

The fission fragment kinetic energy rocket engine (FKR) is a simple application of the awesome fission process. Neutron bombardment of fissionable material within the engine creates fission fragments, which the invention directly converts into high specific impulse spacecraft propulsion.

The FKR engine consists of a heat sink—heat exchanger assembly (HSHE), and a fission zone containing a fission zone shield wall and multiple fission sites. Forming the HSHE structure are a combination heat sink—heat exchanger containing fissionable fuel tubing, neutron injectors, and a molten metal coolant zone. Fuel tubing accepts fissionable vapor-phase material from the spacecraft, delivers it to the fission zone, and injects it into the neutron cone at each fission site. Similarly, neutron injectors accept neutrons from the on-board nuclear reactor, using proven thermal column art, and deliver them to HSHE neutron discharge outlets at each fission site. Molten metal coolant transfers waste heat from the HSHE to spacecraft heat management piping.

At the moment of nuclear fission, approximately 85% of the enormous energies are contained within fission fragments traveling at an average of approximately 4% the speed of light. Fission fragments self-launch outwardly from the fission sites randomly, traveling in all spherical directions. FKR taps into this brief moment to produce high performance spacecraft thrust, before kinetic energy degrades into heat. Fission fragments launching into the hemisphere aft of the fission points escape into space as high specific impulse elements of Newtonboard's action force. Fission fragments launching into the hemisphere forward of fission points slam into the heat sink portion of the invention, transferring their momentum to the spacecraft structure as Newton's reaction force, which is spacecraft thrust.

Due to the manageable, low mass feed rate of fissionable fuel utilized, FKR is well suited for low thrust—long-duration missions at continuous full thrust. Because nuclear energy is the most compact form of energy known, and because fission fragments traveling at 4% the speed of light are the highest-velocity mass adaptable to rocket propulsion known, FKR is a quantum leap above other propulsion technologies competing for a lead role in exploration of the outer regions of our solar system and beyond.

A more complete appreciation of the invention and the attendant advantages thereof will be readily apparent as the same become better understood by reference to the following detailed description, when considered in connection with the accompanying drawings.

### BRIEF DESCRIPTION OF DRAWINGS

FIG. 1 is an overview diagram showing the location and orientation of the invention, relative to other principle elements of a hypothetical spacecraft.

FIG. 2 is a schematic diagram relating structures that control the flow of neutrons from the nuclear reactor core to injection into FKR fission sites.

FIG. 3 is an aft view partly in section and a section view of the FKR, the two views together embodying the present invention.

FIG. 4 is a flow diagram showing operational and control relationships of FKR elements with one another, and with key elements of the spacecraft proper.

### DETAILED DESCRIPTION

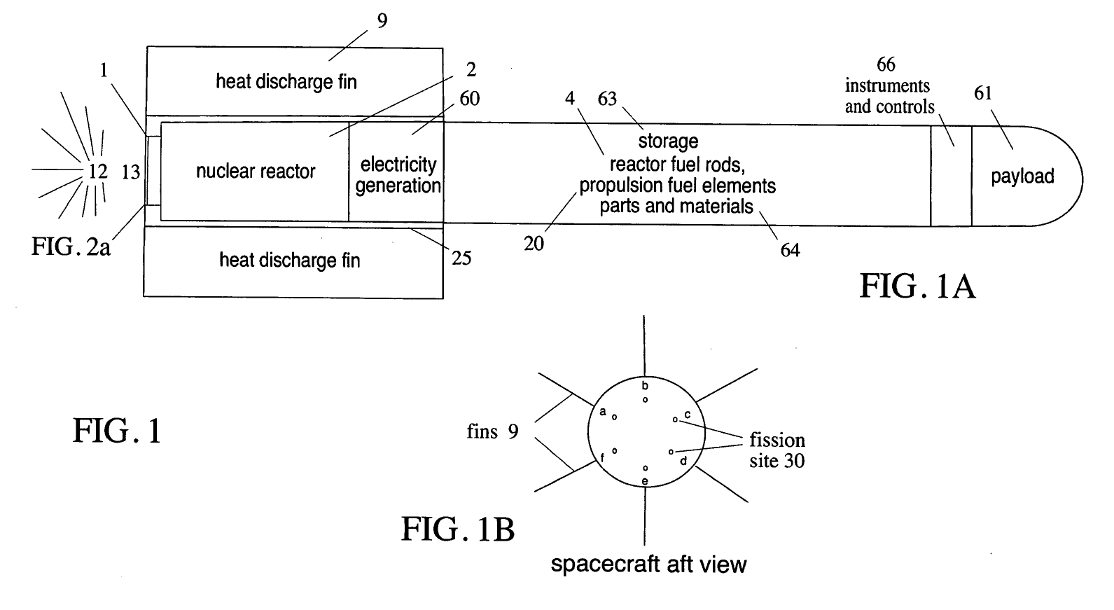

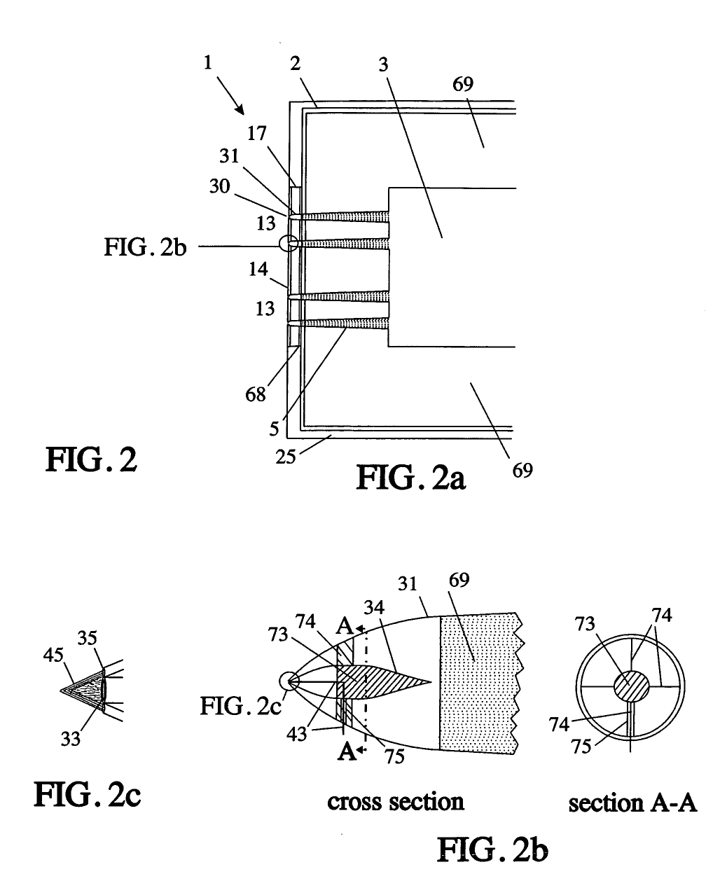

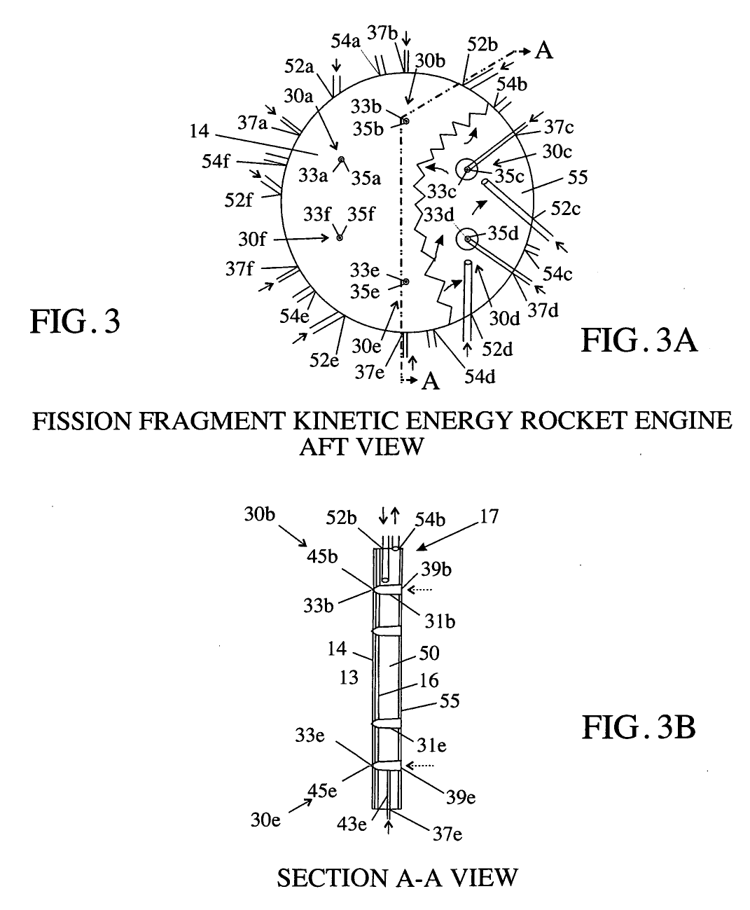

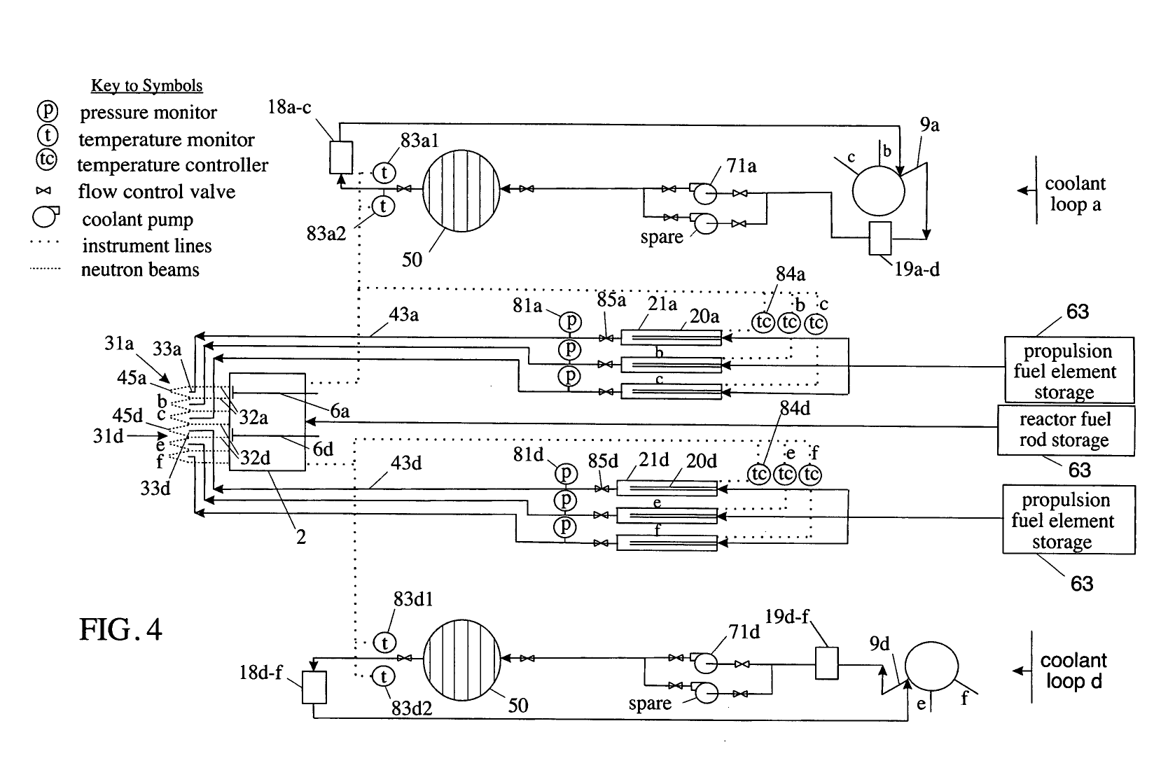

Referring now to the drawings, wherein like reference numerals designate like or corresponding parts throughout the views, there is shown in FIG. 1, FIG. 2, FIG. 3 and FIG. 4 a nuclear fission fragment kinetic energy rocket engine. Said engine structure comprises an HSHE 17 and a fission zone 13 containing a shield wall 14 and multiple fission sites 30. Said HSHE comprises a heat sink 16, fissionable fuel tubing 43, neutron injectors 3, and a molten metal coolant zone 50 with inlet piping 52 and outlet piping 54.

The direct usage of fission fragment kinetic energy to produce spacecraft thrust, the foundation of this invention, allows major structural simplifications from those common to nuclear rocket prior art. The FKR engine has no outer shell or convergent-divergent nozzle, therefore its structure is not required to withstand high operating pressures. By freeing the propulsion fission zone 13 from any form of restricting outer structure aft of its shield wall, a portion of the fission fragments 12 self-launch directly into space at an average velocity of 1.2E9 cm/s,¹² or ˜4% the speed of light. This enormous velocity equates to an unprecedented theoretical specific impulse of 1.22 million seconds.
¹² Weinberg and Wigner, page 131.

The HSHE is fabricated of a high temperature material, for example tungsten, which has an operating temperature up to approximately 3000° C. (5432° F.). Higher melting point materials also are available, tantalum carbide and hafnium carbide with melting points of approximately 7000° F.,¹³ but offer less rocket industry experience. Fissionable fuel tubing, neutron injectors, fission zone shield wall, heat sink, coolant zone wall and coolant piping also are fabricated of a material such as tungsten. The FKR concept utilizes prior art for continuous injection of sub critical-mass quantities of fissionable gas¹⁴ and thermal neutrons¹⁵ into its fission sites 30a-f to cause out-of-reactor nuclear fissions.¹⁶ An alternate method for continuously transferring sub-critical quantities of fissionable atoms to the fission sites, utilizes the vapor pressure of heated fissionable material and the vacuum of space. Other prior art is utilized to collect waste nuclear heat, and transport it to molten metal coolant outlets 54 a-f.¹⁷
¹³ Rom, U.S. Pat. No. 3,202,582, column 1, lines 49-53.

¹⁴ Rom, U.S. Pat. No. 3,202,582, column 4, lines 19+; Rom, U.S. Pat No. 3,574,057, column 3, lines 22+; Weinbaum, U.S. Pat. No. 3,714,782, column 1, lines 63+and column 2, lines 15+.

¹⁵ Etherington 4-91 and 5-83, 84.

¹⁶ Rom, U.S. Pat. No. 3,202,582, column 4, lines 19+; Weinbaum, U.S. Pat. No. 3,714,782, column 1, lines 10+.

¹⁷ Rom, U.S Pat. No. 3,202,582, FIG. 1; Rom, U.S. Pat. No. 3,574,057, FIG. 1; Weinbaum, U.S. Pat. No. 3,714,782, FIG. 1.

FKR is not shape limited, since component configurations are adaptable to create the desired effect. For example, diameters of the HSHE 17 and fission zone 13 can be made significantly larger than the spacecraft diameter, in order to provide surface area for additional fission sites to increase the spacecraft thrust-to-weight ratio. An increased FKR diameter also could lessen the heat load at individual fission sites while maintaining constant spacecraft thrust, or hold constant the heat load at individual fission sites while increasing spacecraft thrust. However, the nuclear reactor core diameter must be at least as large as that of the coolant and fission zones, to allow the reactor to supply neutrons to all fission sites within the fission zone.

In typical usage of the invention, fissionable fuel from the spacecraft enters the FKR engine at tubing connections 37 a-f. Fuel tubing is of circular cross-section, and extends from its receiving connections along the coolant zone forward surface 56, to fission sites 30 a-f. Fuel tubing entering neutron injectors is fabricated of a high melting point neutron absorbing material, for example boron carbide (B₄C),¹⁸ and further protected from neutron intrusion by a covering such as a sheath or block of B₄C material. Fissionable fuel preferably is in the gaseous state. A common form of gaseous fissionable material is uranium hexafluoride (UF₆), having been thoroughly characterized during early gaseous diffusion separations programs.¹⁹ The currently preferred strategy is to store fissionable feed as solids in neutron-safe facilities, for transport to the FKR as heated vapor, or as powder entrained in a carrier gas before vaporizing in heated fuel tubing²⁰ prior to entering the engine.
¹⁸ Rom, U.S. Pat. No. 3,202,582, column 3, lines 65-70; Perry, page 113

¹⁹ Etherington, pages 14-38 through 14-43.

²⁰ Rom, U.S. Pat. No. 3,574,057, column 3, lines 26-33.

The distribution of energy at the moment of nuclear fission previously identified in “Background of the Invention” does not contain a pressure element, reflecting that the fission zone is in a state of continuous vacuum. The differential between heated fuel vapor pressure in its feed tubing and the vacuum of space causes the fuel to flow from its point of entry into the engine 37 a-f through feed tubing to fission sites 30 a-f.²¹ Fuel preferably is injected into the sites through the open end of tubing outlets 33 a-f, as shown in FIG. 2. An alternate configuration is to connect tubing outlets to a fuel injection torus for each fission site at neutron outlets 35 a-f, the tori (not shown) being concentrically located within the circular openings through which neutrons are injected into the fission sites to form neutron cones 45 a-f. Tori would be fabricated of porous tungsten, such that vapor-phase fuel can escape and flow into the neutron cones.
²¹ Rom, U.S. Pat. No. 3,202,582, column 4, lines 19+; Rom, U.S. Pat. No. 3,574,057, column 3, lines 22+; Weinbaum, U.S. Pat. No. 3,714,782, column 1, lines 63+and column 2, lines 15+.

Although several methods of producing neutrons have been used extensively in nuclear work, the most intense and controllable sources of neutrons is provided by nuclear fission reactors.²² Thermal neutrons relatively free from higher energy components are obtained by allowing neutrons from the interior of the reactor to pass through a solid moderating material such as graphite, as shown in FIG. 2. Such devices are designated in the art as thermal columns.
²² Etherington pages 4-91, 5-83.

Mating neutron injector neutron inlets 39 a-f at the forward surface of the invention with thermal columns, extending from the spacecraft nuclear reactor, allows direct delivery of reactor thermal neutrons to neutron injector inlets.²³ The nuclear reactor also provides an on-off control of neutron flow from the reactor²⁴ to the FKR engine. Neutron injectors 31 a-f can be fabricated to produce multi-layered neutron cones, although those shown in FIGS. 2 and 4 are a single cone layer. In determining quantity of cone layers, mission fission efficiency and nuclear reactor mass are key considerations. Employing multi-layered cones to lessen the escape paths will result in higher fission efficiencies, with the penalty of higher-powered reactors being required for supply of neutrons to propulsion.
²³ Etherington, pages 4-91 and 5-83, 84.

²⁴ Etherington, pages 4-91 and 5-83, 84; Rom, U.S. Pat. No. 3,202,582, column 6, lines 3+.

The unique FKR structure is dictated by its tapping directly into nuclear fission, before its powerful kinetic energy forms degrade into heat. Fission fragments transferring their momentum into the fission zone shield wall to create spacecraft thrust also deposit a waste heat load, which the invention manages. The first step is to limit the overall fissionable fuel feed rate, which inherently limits spacecraft thrust. However, this low consumption of fissionable fuel leads to the potential for continuous, high specific impulse propulsion over long durations of time. Therefore, the FKR engine is a low thrust—long duration space propulsion device, and is not a candidate for planetary liftoff missions.

Spacecraft thrust sufficiently high for long duration space missions is achieved by employing multiple fission sites within the fission zone. The fuel feed to each fission site must be within the capacity for heat transfer from each fission site through the fission zone shield wall and heat sink, to the molten metal coolant, and transfer of heat-bearing coolant to the spacecraft coolant piping at HSHE outlets 54 a-f. The currently preferred fissionable fuel feed rate for each site is in the range of one milligram of fully enriched uranium-235 per second, or equivalents of uranium-233, plutonium-239, or mixtures thereof. The current criteria for heat transfer sequences is that structural metal temperatures be a minimum of 1000° F. below the metal melting point, and maximum temperature of the coolant to be a minimum of 500° F. below its boiling point.

Fissionable fuel enters fission sites 30 a-f, and flows through the neutron cone interiors as it is urged toward the vacuum of space. As fuel atoms attempt to pass through the neutron beams they are bombarded by neutrons, causing fissions. Assuming a single layer of neutron beams forms each neutron cone, a portion of the fuel will encounter neutrons and fission, and a portion will pass through minute spaces between neutrons, and escape the fission site. A single layer of neutron beams is the simplest configuration to make and use, but has the lowest fission efficiency. The potential for utilizing additional beam layers, or other patterns such as direct impingement, is obvious.

In order to minimize the quantity of neutrons in each neutron cone necessary to effectively bombard fissionable fuel atoms as they pass through the cone, the base diameter should be minimized. The smaller the base diameter, the fewer neutron beams are required. Typical fission cone dimensions currently preferred are base diameter less than one centimeter, and height-to-base diameter ratios between approximately one and three.

The portion of fission fragments 12 entering the hemisphere aft of each fission site become elements of Newton's action force, carrying their total energy with them. Fission fragments entering the hemisphere forward of each fission site plow into the fission zone shield wall 14, transferring their momentum into the spacecraft structure to create Newton's reaction force. Although the stopping distance of fission fragments in tungsten is only a few microns, a shield wall thickness of several hundred times the stopping distance is currently suggested.

Fission fragments burrowing into the fission zone shield wall 14 release their kinetic energy as heat, which rapidly distributes itself throughout the shield wall and heat sink mass due to the high thermal conductivity of tungsten and short heat transfer distances. HSHE coolant rapidly absorbs the heat and transports it from the heat sink through coolant zone 50, to coolant outlets 54a-f at the engine interface with the spacecraft heat management system. Waste heat either will be radiated into space by heat rejection fins, or utilized in some spacecraft function such as thermionic generation of electricity or payload support.

The FKR baseline for performing the transfer of heat recited above utilizes molten metal coolant prior art developed during decades of breeder reactor programs in the United States and abroad.²⁵ The latest operational nuclear reactor to utilize molten metal coolant technology, prior to its retirement in 1992, is the Fast Flux Test Facility.²⁶ FKR injects fresh coolant 52a-f directly onto the aft wall of the heat sink 16. The angular orientation of coolant piping at coolant inlets 52a-f (FIG. 3), aided by tungsten fins disposed onto the forward and aft walls of the coolant zone (not shown), create a swirling flow along the heat sink. Coolant sweeps throughout the coolant zone with its heat load along the less heated forward coolant zone wall 55, and exits through outlets 54a-f.
²⁵ Etherington, pages 13-80 through 13-104; U.S. Department of Energy, FFTF@rl.gov.

²⁶ U.S. Department of Energy, FFTF@rl.gov.

Because prior art breeder reactors operated at moderate temperatures, compared with rocket propulsion, sodium [melting point (M.P.) 97.8° C., 208° F.; boiling point (B.P.) 883° C., 1621° F.] was the preferred coolant. However, higher melting and boiling point metals were evaluated, up to tin (M.P. 232° C., 449° F.; B.P. 2270° C., 4118° F.).²⁷ Other candidate coolants representing obvious extensions of the art include beryllium (M.P. 1284° C., 2343° F.; B.P. 2767° C., 5013° F.), and titanium (M.P. 1800° C., 3272° F.; B.P. 3260° C., 5900° F.).²⁸
²⁷ Etherington, page 13-81, 82.

²⁸ Perry, page 113, 127; Periodic Table of the Elements.

Conventional practice in the art is to calculate rocket performance parameters such as force (thrust) based on the action force. Each fission fragment traveling generally aft creates its individual action force. A fraction of each force acts parallel to the spacecraft axis, their sum creating the total action force. An unusable fraction acts laterally or perpendicular to the axis, and represents waste energy. The fraction of each fission fragment's total force that contributes to the action force, or to the waste force, is dependent on its angle of travel relative to the spacecraft axis.

In the two right-angled triangles shown below, each hypotenuse length (dashed line) represents 100% of the total force exerted by the fission fragment along its path. The action force portion of each fission fragment is mathematically expressed as a vector (bold line) parallel to the spacecraft axis. The waste force is expressed as a normal-thickness line perpendicular to the axis.

A fission fragment traveling parallel to the axis has a directional efficiency of unity: cosine 0°/(cosine 0° +sine 0°)=1/(1+0)=1=100%. A later or perpendicular fragment has zero efficiency: cosine 90°/(cosine 90° +sine 90°)=0/(0+1)=0%. Similarly, a fragment traveling at a 60° angle relative to the spacecraft axis will have a directional efficiency of 36.6%: cosine 60°/(cosine 60°+sine 60°)=0.5000/(0.5000+0.8660)=˜0.366=˜36.6%. A fragment traveling at 45° will be 50% efficient, and at 30° will be 63.4% efficient.

Utilization of the random distribution of fission fragments for rocket propulsion in this invention is currently subject to the two energy usage inefficiencies illustrated above. Firstly is the Newton's law factor. The reaction force, which propels the rocket forward, contains only one half of the total fission fragment kinetic energy created by nuclear fission. Therefore, a Newton-based value for the maximum portion of fission kinetic energy that can become useful spacecraft thrust is approximately 50%, allowing that fragments traveling perpendicular to the axis are waste energy, containing neither action nor reaction forces significantly impacting spacecraft thrust.

Secondly is the directional factor. Because the distribution of fission fragments is random, only the fractions of fission fragment force that are parallel to the spacecraft axis contribute to the spacecraft action and reaction forces. For example, the fraction of previously recited fission fragments traveling in the hemisphere forward of fission sites, having an average angle of 45° with the spacecraft axis, will contribute 50% of their total force to the reaction force, which drives the spacecraft forward.

Although only a fraction of the total kinetic energy of fission is converted into spacecraft thrust, the enormity of fission kinetic energy specific impulse over chemical and other nuclear rockets vastly overwhelms the efficiency loss of this invention.

The following example of out-of-reactor fission fragment propulsion, in combination with the drawings, claims, and other portions of this specification, are set forth as an operative embodiment of the FKR structure, and how it would function. The example addresses fission energy management, the relation and interaction of FKR components with one another and with relevant spacecraft components, thermal energy management, and the overall FKR system operation and control.

Fission Energy Management

The fissionable fuel in this sample analysis is fully enriched uranium isotope number 235 (U). The FKR manages fission thermal energy by precisely metering a small quantity of fissionable atoms (atm) and neutrons (n) into each fission site, concurrent with removal of energy by fission fragment escape, heat supply for electricity generation, and spacecraft heat discharge fins. By limiting the quantity of material fissioning at any given moment to well below critical mass, an excursion into the catastrophic level is avoided. The U feed rate to each fission site used in this analysis to establish representative structural and operational conditions and parameters is 1 milligram per second (mg/s), which on an atomic scale equates to 2.56E18 (2.56 billion billion) U atoms per second per fission site:

$${U}_{a} = \frac{{U}_{m} \cdot {N}_{A}}{{W}_{a}}$$

$$where \text{:} \qquad \begin{matrix}{U}_{a} = U atom feed rate . \\ {U}_{m} = U mass feed rate . \\ {W}_{a} = U atomic weight . \\ {N}_{A} = Avogadro ' s number .\end{matrix}$$

A combination of 10 fission sites fire continuously in this example, each site conservatively located no closer to another than 50 centimeters (˜20 inches). The total engine steady-state U feed rate is E-2 g/s, which equates to 2.56E19 U atoms per second.

Thermal Columns

The on-board nuclear reactor (reactor) to support FKR propulsion is a high neutron flux, state of the art concept available at time of the mission. The reactor neutron flux and thermal column chosen for this analysis are neutron flux of E17 n/cm²-s at the reactor core, and thermal column diameter at the reactor core of 5.71 cm. This combination provides 2.56E19 neutrons per second to support propulsion fissions, thereby yielding a neutron:U atom ratio of 1. One end of the graphite moderated thermal columns penetrates the reactor shield wall and interfaces with the reactor core, the other end joins the reactor core to FKR neutron injectors. Each thermal column opening into the reactor core receives a neutron quantity of 2.56E18 neutrons per second. Similarly, had a neutron:atom ratio of 3:1 been the mission requirement, an˜10 cm diameter thermal column opening at the reactor core would have been necessary:
N_{C}=F_{C}·A_{C}
where:
N_{C}=neutrons entering thermal columns at reactor core.
F_{C}=neutron flux at reactor core.
A_{C}=area of thermal column at reactor core penetration.

Thermal neutrons relatively free from higher energy components are obtained by passing neutrons from the reactor interior through a mass of moderating material, such as graphite, contained within thermal columns.²⁹ Neutrons which diffuse all the way through are so well moderated as to be almost in thermal equilibrium with the graphite.³⁰
²⁹ Etherington, page 4-91.

³⁰ Etherington, page 5-105.

Thermal columns can have either a cylindrical or truncated cone configuration. In this example, conical thermal columns have converged into 3 cm internal diameter connections at the neuron injector interface. Because of the decreasing cross-sectional area of thermal columns as neutrons travel from the reactor to neutron injectors, the neutron flux density entering FKR will have approximately doubled over that at the thermal column entrance:
F_{co}=F_{c}·A_{c}/A_{ci}
where:
F_{co}=neutron flux at thermal column outlet.
F_{c}=neutron flux at reactor core.
A_{c}=area of thermal column at reactor core penetration.
A_{ci}=area of thermal column-neutron injector at interface.
   Neutron Injectors

When thermal neutrons reach the thermal column interface with the FKR at the neutron injectors (FIG. 2a), the neutrons are traveling at approximately 2200 meters per second.³¹ On exiting the thermal column graphite moderator, neutrons enter and pass through the graphite neutron moderator material within neutron injectors. Neutrons then enter the vacuum of space within the hollow portion of injectors, and are guided along streamlined sidewall paths to injector exits as shown in FIG. 2b, driven by their momentum.
³¹ Etherington, page 5-53.

A strategy of the invention is to configure structures to maximize neutron flux at the plane of neutron injection into neutron cones. In this manner the probability of neutrons striking a U atom are maximized, thereby maximizing fission efficiency. Implementing this strategy begins with selection of an on-board nuclear reactor designed to operate at high neutron flux levels. Thermal columns of conical shape increase the volume density of neutrons; however, the structure of neutron injectors offer the greatest potential for enhancement of out-of-reactor fission efficiency. The outer wall of neutron injectors in this example neck down from a 3 cm internal diameter at their interfaces with thermal columns, to an internal diameter of 5 mm at the neutron cone interface (FIGS. 2b and 2c). To significantly increase the neutron flux of beams entering fission cones, the interior of neutron injectors contains an axial beam focusing element as shown in FIGS. 2 and 3. When the torroidal-shaped opening into the fission cone is configured 1 millimeter in width, the reduced injector cross-sectional area causes the neutron flux to increase to approximately 2.85E18 n/cm²-s:
F_{nc}=F_{c}·A_{c}/Aᵢ
where:
F_{nc}=neutron flux at neutron cone inlet.
F_{c}=neutron flux at nuclear reactor core.
A_{c}=area of thermal column at nuclear reactor core.
Aᵢ=area of cross-section at injection.

At fission site parameters of 1 milligram per second of U feed, neutron: U atom ratio of 1, neutron cone base and height each five millimeters, and neutron beam thickness of one millimeter, more that two billion billion (˜2.56E18) neutrons per second beam through more than two billion billion (˜2.56E18) fissionable atoms per second, within a neutron beam volume of only ˜23.6 cubic millimeters. It is logical to project the quantity of fissions that take place under these conditions will be significant. Higher values of neutron:U atom ratios logically will increase fission efficiencies, as will concentration of neutrons at the point of injection by reducing the beam thickness from 1 millimeter to 1 micron, and potentially further as nanotechnology develops.³²
³² Kahn, pages 98-119.

It is likely that quantitative nuclear propulsion parameters have not been sufficiently established to allow prediction of out-of-core fission efficiencies at this time, or to establish the efficiency level attainable by a comprehensive development program. Nor were nuclear propulsion efficiency parameters quantified prior to or during prosecution of complex, precedent-setting Rom U.S. Pat. No. 3,202,582, Rom U.S. Pat. No. 3,270,496, Rom U.S. Pat. No. 3,574,057 and Weinbaum U.S. Pat. No. 3,714,782 for nuclear gas core spacecraft propulsion. The patents were granted on the basis of probable behavior for advanced nuclear propulsion concepts, not on proven “specific values for each of the parameters.” Applicant submits that fission efficiency uncertainties of prior art nuclear gas core rocket patents and the FKR patent application, due to mutual absence of proven quantified values, are relevant to efficiency and optimization rather than to operability and utility. The four pioneering patents logically should have been, and were, granted.

Thermal Energy Management

The rate of uranium fissions within the fission zone and the portion of fission fragments impacting the fission zone shield wall, determine thermal releases into the wall. The portion of fission fragments exiting the fission zone as propulsion elements carry their total energy with them. The portion burrowing into the shield wall releases kinetic energy as thermal energy. Molten metal coolant rapidly absorbs this high-temperature by-product heat, and transports it to the spacecraft heat management system. Other thermal excesses of the spacecraft, including waste heat from the nuclear reactor and from thermionic electricity generation, similarly will be radiated into space by the spacecraft heat discharge fins.

Summary of bases for the representative example:

Ten fission sites fire continuously, total U feed=E-2 g/s=2.56E19 atm/s, 50% of feed atoms fission, 50% of fission fragments escape aft.
FKR components are tungsten, M.P. 3370° C.
Neutron absorption material is boron carbide, M.P. 2450° C.
Coolant is molten titanium (Ti), M.P. 1800° C., B.P. 3260° C.
A nuclear reactor provides neutrons to cause fissions in the FKR fission zone.
Fission zone equilibrium temperature is 2800° C.
FKR coolant discharge at 2700° C. is piped to the spacecraft heat management system, cooled to 1950° C. and returned to the FKR, re-heated by thermal energy from the fission zone, and the cycle is continued. Steady-state fission energy remaining in the fission zone following fission fragment escape (ie. entering fission zone shield wall) is 4.63E7 calories per second:
   Q_{c}=Uₜ·Ê_{f}·Êᵣ·Q_{f}
   where:
Q_{c}=steady state heat entering shield wall.
Uₜ=U atom feed rate, total to all fission sites.
Ê_{f}=fraction of U atoms that fission.
Êᵣ=fraction of fission fragments retained in heat sink.
Q_{f}=energy per fission.

Thickness of the combination fission zone shield wall and heat sink to allow thermal conduction to move heat from the fission zone into coolant is 5.6 millimeters, approximately 800 times the stopping distance of fission fragments in tungsten:
Q_{c}=k_{w}A(Δt/x)
where:
Q_{c}=steady state heat entering fission zone shield wall.
k_{w}=conduction heat transfer constant for tungsten.
A=shield wall/heat sink cross-section surface area.
Δt=temperature differential, fission zone and coolant.
x=heat flow path distance (tungsten thickness).

Coolant flow to transport heat from FKR to spacecraft heat management is 1.05E6 grams per second:

$${m}_{Ti} = \frac{{Q}_{c}}{{k}_{Ti} \cdot Δ {t}_{Ti}}$$

$$where \text{:} \qquad \begin{matrix}{m}_{Ti} = mass flow rate of molten titanium coolant . \\ {Q}_{c} = steady state heat entering heat sink . \\ {k}_{Ti} = heat capacity constant for titanium coolant . \\ Δ {t}_{Ti} = temperature differential , coolant outlet and inlet .\end{matrix}$$

At this point in the example, steady-state operating conditions are attained, and the fission zone wall does not melt or loose structural integrity. FKR by-product heat has been transferred from the fission zone into molten metal coolant, delivered to spacecraft heat management piping, and lowered-temperature coolant returned to the FKR to repeat the cycle.

As heretofore recited, at the moment of fission approximately 85% of total energy is manifest in the kinetic energy of fission fragments, the remainder being distributed between beta particles, gamma rays, neutron and neutrinos. The following sixteen elements make up 92.3 percent of the total fission fragment mass: ³³

| Element | Percent | M.P., ° C. | B.P., ° C. |
|---|---|---|---|
| Rare Earths: | | | |
| Nd neodymium | 9.9 | 1024 | 3027 |
| Ce cerium | 6,0 | 795 | 3468 |
| La lanthium | 3.1 | 920 | 3470 |
| Pr praseodymium | 3.0 | 935 | 3127 |
| Pm promethium | 1.1 | 1027 | — |
| Sm samarium | 0.7 | 1072 | 1900 |
| Eu europium | 0.5 | 826 | 1439 |
| Gd gadolinium | 0.1 | 1312 | 3000 |
| Rare Gases | 16.2 | gas | gas |
| Mo molybdenum | 12.5 | 2610 | 5560³⁴ |
| Cs cesium | 6.4 | 29 | 690 |
| Ru ruthenium | 5.4 | 2500 | 4900 |
| Sr strontium | 4.4 | 768 | 1380 |
| Te tellurium | 4.0 | 450 | 990 |
| Ba barium | 3.2 | 714 | 1640 |
| I, Briodine, bromine | 0.8 | 113, −7 | 183, 58 |
| Other | 7.7 | — | — |
| Total | 100 | | |

³³ Etherington: page 2-4, Table 4; page 11-12, Table 4.

Fission fragments penetrate into the fission zone shield wall 14 at varying depths, dependent on fragment mass, velocity and angle of impact. During the short stopping distance, fragment kinetic energy is converted into spacecraft thrust and heat. In the example, steady-state temperature of the fission zone shield wall is 2800° C. Because the boiling points of elements that make up fission fragments are below the shield wall temperature, except five rare earths, molybdenum and ruthenium, the vapor pressures of these elements will reach or exceed 760 millimeters of mercury, the element atom instantly disappearing into space in gaseous form. All elements have melting points below shield wall temperature and will liquefy, their varying vapor pressures determining how rapidly each vaporizes into space vacuum.

Bombardment of the shield wall by fission fragments, followed by their vacuum-assisted removal, will cause a microscopic roughening of the surface. However, a beneficial by-product of bombardment will naturally occur due to the large percentage of high melting point molybdenum in fission fragments, and also the presence of ruthenium. The vapor pressure of molybdenum at 3102° C. is only 1 millimeter of mercury,³⁵ and data extrapolation indicates molybdenum and ruthenium will be retained in a solidified form at the 2800° C. temperature. Natural deposition of fission fragment molybdenum and ruthenium on the shield wall surface will complement the already stabile performance of tungsten during continuously powered missions into deep space. Mass of “hobo” molybdenum (M_{Mo}) depositing itself at the fission zone shield wall of the example will be approximately 18 pounds per year:
M_{Mo}=UₜÊ_{f}·Êᵣ·kₜ·k_{ff}
where:
Uₜ=U atom feed rate, total to all fission sites.
Ê_{f}=fraction of U atoms that fission.
Êᵣ=fraction of fission fragments retained in heat sink.
kₜ=constant for time conversion.
k_{ff}=constant for fission energy % to fission fragments.

At this point in the example, steady state nuclear and thermal relationships of individual FKR components and the rocket system as a whole have been established.
³⁵ Perry, page 151 Table 7.

System operation and control FIG. 4 is a flow diagram showing operation and control relationships between FKR components, and their interaction with relevant components of the spacecraft. All ten fission sites of the example operate continuously throughout the mission, and each fission site and its support components are configured and operated identically. Prior to FKR startup, the nuclear reactor 5 is powered up to mission startup level, using proven technology. Concurrently—coolant pumps 71, coolant zone 50, heat discharge fins 9, U feed control boxes 21, spacecraft molten metal coolant, and plumbing—are activated as described below. During this period, nuclear reactor seal rods 6 are in closed position, blocking the flow of reactor neutrons to propulsion.

Of the alternative concepts for U feed, the heating of metallic U fuel elements 20 was selected because of its no-moving-parts. U fuel elements are robotically moved from storage and placed inside U feed control boxes 21, box lids then shut and U feed valves 23 closed. Control boxes are brought to startup status by increasing their temperatures 90, causing U vapor pressure within the boxes to reach startup level equilibrium for the mission. Electrical heat-traced U feed tubing 42 connecting control boxes to the FKR fissionable fuel tubing inlets 37 are energized, to prevent the later flow of U vapor through the feed lines from condensing.

Coolant flow is actuated by energizing heat-traced coolant pumps 70 and piping, to melt the solidified coolant they contain. Concurrently, electric heaters melt solid coolant inside the coolant zone 50. Coolant flow has been successfully actuated when (1) coolant freely circulates through pumps, coolant zone, heat discharge fins, and all coolant piping; (2) FKR thermal equilibrium has been reached; and (3) all instruments and controls are functional.

When pressure monitors 81 verify that U feed lines are open to the vacuum of space, U feed valves 23 are opened. Because equilibrium U vapor pressure of the heated fuel tubes inside feed control boxes exceeds the pressure of space vacuum, a continuous stream of vaporized U atoms flows through the feed lines and FKR fissionable fuel tubing inlets 37, into the neutron injectors 31 and on into the fission sites to form into neutron cones 45. As U vapor atoms leave the feed control boxes, new U atoms vaporize from the heated fuel rods, satisfying the basic physics law of constant vapor pressure at constant temperature.

Concurrent with initiation of fuel feed, nuclear reactor channel seal rods 6 are cycled, and thermalized reactor neutron beams 41 bombard U atoms as they pass through the neutron cones 45. Temperature sensors 96 at coolant zone 50 exits transmit electronic signals to the computer network, a temperature increase verifying fissions are taking place. Moderate increases indicate that specification quantities of U are fissioning. High temperatures indicate excessive fuel feed is undergoing fission, requiring immediate fuel feed and/or neutron injection reduction, thereby initiating computerized troubleshooting activities. Feed box temperature controllers 84 and reactor power are increased proportionately, increasing the rate of fissions while holding the ratio of neutrons to U atoms constant. During incremental increases, temperatures throughout the spacecraft thermal management system are monitored. When temperatures rise to mission steady state values, stable U feed and reactor neutron injection rates are locked into the control system. Steady state is attained when (1) all spacecraft systems are operating within specification, and (2) temperatures throughout the spacecraft are within specification and hold steady.

At this point in the example, requirements for operability and utility have been satisfied.

Individual components which comprise the invention—their identification numbers and locations within the figures, references to prior art on which the components are based, and principles of physics essential to the invention are listed below: Component designations “a-f” reflect a 6 fission site configuration of drawings, simplified to eliminate repetitive details, rather that the 10 fission site configuration of the text example.
(a) Fissionable fuel tubing, FIG. 3, 33a-f.
   Prior art references: Weinbaum's U.S. Pat. No. 3,714,782 equivalent tube; Rom's U.S. Pat. No. 3,202,582 conduit; Rom U.S. Pat. No. 3,574,057 col. 3 lines 22+.
(b) Neutron injector, FIG. 3, 3 1a-f.
   References: Weinbaum U.S. Pat. No. 3,714,782 col. 1 lines 10+; Rom U.S. Pat. No. 3,202,582 col. 4 lines 19+; Rom U.S. Pat. No. 3,574,057 col. 3 lines 1+.
(c) Reactor neutron seal rod, 6; FIG. 4.
   References: Rom col. 6 lines 3+; Nuclear Engineering Handbook pages 4-91 and 5-83, 84.
(d) Fission sites, FIGS. 1, 2 and 3, 30a-f.
   Means to cause nuclear fissions, which launch fission fragments randomly from the points of fission.

References: Weinbaum U.S. Pat. No. 3,714,782 FIG. 1; Rom U.S. Pat. No. 3,202,582 FIG. 1; Rom U.S. Pat. No. 3,574,057 FIG. 1.
(e) Means to transmit a force (thrust) against the spacecraft structure in the forward direction, caused by the high-velocity movement of fission fragments traveling generally in the aft direction.
   References: Pederson page 15, Young and Freedman 8-7, Zaehringer page 54.
(f) Heat sink—heat exchanger assembly, FIGS. 1, 2 and 3, 17.
   References: Rom U.S. Pat. No. 3,574,057.

In summary of the above listing, essential details of invention components (a), (b), (c), (d) and (f) have been defined in terms of their prior art and/or scientific basis. Four prior art nuclear rocket patents are relevant to the FKR disclosure: Rom U.S. Pat No. 3,202,582 (1965), Rom U.S. Pat. No. 3,270,496 (1966), Rom U.S. Pat. No. 3,574,057 (1971) and Weinbaum U.S. Pat No. 3,714,782 (1973), for which applicable patent columns and lines have been recited. Essential details of components (c), (d) and e were defined in terms of their scientific basis or prior art. FIGS. 1, 2 and 3, with their associated texts, recite the simple structure and operative embodiment of the invention. Each component was identified, and structural and operational relationships addressed in the figures and text, with references for convenience during prosecution of the invention and later make-use activities.

This invention is the union of a heat sink—heat exchanger assembly with an out-of-reactor fission zone, to form into a unique unobvious structure, comprised of components utilizing patented prior art now in the public domain and standard text book art relevant to the invention. Each component that is part of a patent has previously been judged by PTO to be operable and to have utility. By combining a foundation of prior art components and classic textbook theory with detailed definition of the invention structure and its operation, a new use for old art has been disclosed, sufficient to allow those experienced in art encompassed by the invention to make and use it.

While a preferred embodiment of the fission fragment kinetic energy rocket engine has been shown and described, it will be apparent that various structural modifications can be made without departing from the spirit of the invention or the scope of the subjoined claims. By way of example, fissionable fuel could be fed into fission cones through tori, rather than through open tubing as shown in FIG. 1. Neutrons could be beamed through thermal columns configured to form neutron cones of individual beams, or through slotted thermal columns configured to form slotted neutron cones. An ultimate configuration for highly efficient bombardment of fissionable fuel might prove to be a direct atomic scale impingement, made possible by the evolution of nanotechnology.

I claim:

1-3. (canceled)

4-7. (canceled)

8. A nuclear fission fragment rocket engine, comprising:
a. A heat sink—heat exchanger assembly, comprising a heat sink, neutron injectors, fissionable fuel tubing, and a coolant zone.
b. An out-of-reactor fission zone comprising a shield wall and a plurality of fission sites.
c. Means to continuously feed sub-critical mass quantities of fissionable material into said fission sites.
d. Means to continuously deliver a predetermined pattern of thermal neutrons into said fission sites.
e. Means to cause thermal neutrons to bombard said fissionable material within said fission sites, thereby causing out-of-reactor nuclear fissions.
Whereby, said spacecraft will be urged forward.

9. Said rocket engine as in claim 8, further comprising:
a. Said shield wall disk-shaped and contiguous with said heat sink, in concentric relationship with said heat sink, the planes of their surfaces parallel to one another.
b. Said coolant zone disk-shaped, concentric with and adjacently disposed to said heat sink, said coolant zone bounded by a cylindrical outer shell, forward wall, and said heat sink.
c. Said fissionable fuel tubing having one end in communication with rocket plumbing for the supply of vapor-phase material, and the other end opening into neutron cones at said fission sites.
d. A plurality of said neutron injectors disposed within said assembly, in structural communication with and sandwiched between said fission sites and said coolant zone forward wall.

10. A nuclear fission fragment rocket engine, comprising:
a. A heat sink—heat exchanger assembly, comprising a disk-shaped heat sink, neutron injectors, fissionable fuel tubing, and a coolant zone.
b. An out-of-reactor fission zone comprising a shield wall and a plurality of fission sites, said fission zone being disk-shaped, concentrically disposed adjacent to said heat sink, and encompassing the shield wall and all fission sites.
c. Means to continuously deliver sub-critical mass quantities of fissionable material into said fission sites by utilizing the vacuum of space, rather than components with moving parts.
d. A plurality of neutron injectors, one end in communication with thermal columns from the on-board nuclear reactor and the other end opening into fission sites.
e. Means to cause thermal neutrons to continuously bombard said sub-critical mass fissionable material, thereby causing out-of-reactor nuclear fissions.
Whereby, said spacecraft will be urged forward.

11. Said rocket engine as in claim 10, further comprising:
a. Said neutron injectors with outer shells breast shaped, conical, or combinations thereof.
b. Neutron beam focusing elements within said neutron injectors, in structural communication with and concentrically disposed within said outer shells.
c. Said focusing element having a free end terminating in close proximity to the vertical exit plane of neutron injector neutron outlets.
d. A high melting point neutron absorbing material, such as boron carbide, disposed within said neutron focusing element, and/or formed into a sheath surrounding said fuel tubing disposed within said neutron injectors.
e. Fissionable fuel tubing entering said neutron injector outer shell and interior neutron absorption material, opening into said fission sites.
f. Said nuclear injector outer shell and focusing element concentrically deposed to form neutrons into cones of predetermined dimensions that surround the U feed tubing outlets within said cones.
g. The surface of said outer shell and focusing element configured to gradually decrease the neutron flow path crossectional area between neutron entry into and exit from said neutron injectors.
h. Means to cause said fissionable atoms to be bombarded while passing through said neutron cones, thereby causing nuclear fissions.
